(19) United States
(12) Patent Application Publication
(10) Pub. No.: US 2008/0033720 A1
(43) Pub. Date: Feb. 7, 2008

(54) A METHOD AND SYSTEM FOR SPEECH CLASSIFICATION

(76) Inventors: Pankaj Kankar, New Delhi (IN); Tanveer Afzal Faruquie, New Delhi (IN)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/462,396

(22) Filed: Aug. 4, 2006

(51) Int. Cl. G10L 15/26

(52) U.S. Cl. 704/235

(57) ABSTRACT

The present invention deals with a method and system for classifying at least one speech-user-utterance in a speech classification system to one of a plurality of pre-defined class types. The method comprises transcribing automatically the at least one speech-user-utterance to obtain at least one automatic-transcribed-text and estimating an estimated-transcribed-text corresponding to the at least one automatic-transcribed-text. The method further comprises classifying the at least one speech-user-utterance based on the estimated-transcribed-text. The estimated-transcribed-text is estimated based on at least one statistical model.

### FIELD OF THE INVENTION

The present invention relates generally to speech recognition and more specifically, to a method and a system for speech classification.

### BACKGROUND OF THE INVENTION

Speech enabled applications have become more common with time and advancement of technology. They are built using conversational systems that allow users to interact with machines using speech. The speech enabled applications can either be directed dialog based or natural language based. In the directed dialog system, a user responds to the directed dialog system prompts rather precisely in order. The directed dialog system exploits the knowledge of a limited context therefore a speech recognizer may need to handle small grammars at each prompt. Though this improves the speech recognition accuracy, the dialogs are rigid and force the user to model his or her response in a way the directed dialog system desires it. On the other hand, the natural language systems are much closer to human-human interface but are more sophisticated. They let users to specify their requests in their own words, but they need high quality speech recognition and a high level of Natural Language Understanding (NLU) capability.

Several real life applications, such as call centers, are based on correct classification of user utterance. The first task in any call center is to direct the user to the appropriate department depending on the user's request. This can be done using either a human personnel or by an Interactive Voice Response System (IVRS). In the former method, a skilled human personnel is required and the latter method results in a complicated user interface and cannot be scaled easily.

Natural language call classification systems mimic the capability of human routing agents to provide natural human like interface. For satisfactory performance, natural language call classification systems need to have a high level of classification accuracy. This in turn needs an accurate Speech Recognition system and a high quality NLU Tool. The accuracy of the system can depend on the kind of classifier used in the natural language call classification system. A classifier can be built using different approaches, for instance a statistical approach or a vector-based approach. In the statistical approach the likelihood of a set of query words being associated with a particular class is estimated and statistical techniques are used to determine the likelihood. In the vector based approach as discussed in “Vector-Based Natural Language Call Routing” Computational linguistics, 25(3): 361-388, 1999, each call is considered as a vector of words and vector processing methods are used to find the correct classification of the call.

An Automatic Speech Recognizer (ASR) transcribes a speech to as close as possible to a human-transcribed-text of the speech. However ASRs are very sensitive to a number of factors like the ambient noise, the accent of the caller or the calling medium (like land-line, wireless or VOIP), which reduces their accuracy drastically and result in misrecognition errors. The misrecognized text when fed to an NLU classifier can result in poor classification accuracy even if the classifier is of high accuracy. Usually the ASRs, instead of producing a single best recognized sentence, give a certain number, N, of best recognized sentences along with their confidence scores. The best N-sentences produced by the ASR are known as the N-best list.

Various existing methods have tried to improve the classification accuracy. The existing methods try either to improve the accuracy of the classifier itself or sanitize its usage or use some extra information to improve the performance. The techniques which try to improve the accuracy of the classifier comprise boosting, discriminative training and constrained minimization.

A technique known as Adaptive Boosting (Adaboost), as disclosed in “Boosting with prior knowledge for call classification”, IEEE Transactions on Speech and Audio Processing, Vol. 13, No. 2, March 2005 combines multiple weak learners along with the application's prior knowledge into a powerful composite classifier. Learners are classification algorithms that perform only slightly better than random guessing. Boosting works by asymptotically minimizing an empirical error. Samples for training the weak classifier are picked up according to a weight distribution. Initially all the samples are given the same weights. Boosting gives higher weights to those samples that have been wrongly classified and lesser weights are given to those samples that are correctly classified. The next classifier is trained with samples drawn based on the new weight distribution. Hence, the wrongly classified samples are given more emphasis in the next stage. During the testing phase the classifiers are combined, with the classifier having least error during the training stage getting more weight. But the technique is useful only when the input to be classified is not noisy.

Like boosting which combines weak classifiers of the same type, combining classifiers of different type can also improve accuracy. In Constrained Minimization, as disclosed in “Multiple classifiers by constrained minimization” in proceedings of International Conference on Acoustic, Speech and Signal Processing, 2000, uses three classifiers, the decision is made by the first two classifiers if they agree, and arbitrated by the third when they disagree. The third classifier may be explicitly trained on disagreements of the first two using minimum error training and can make a choice only on a subset of topics.

This helps when class boundaries cannot be accurately learned by single classifier set. But it is of marginal use when the input to classifier is itself noisy.

Some of the existing techniques try to reduce the impact of speech recognition errors on speech classification and to minimize manual effort required in tagging data. A technique as disclosed in Cheng et. al, “Improving End-to-End Performance of Call Classification Through Data Confusion Reduction and Model Tolerance Enhancement” in Proceedings of INTERSPEECH 2005, select a list of ASR transcribed text for training the classifier by looking at the distance of the generated N-best sentences from the human transcribed text. The classifier is trained on the single best hypothesis and the N-best decoding results. They experiment with different values of N. In this way, the technique tries to sanitize the data with which they train the classifier. However this sanitization can be applied only a training time since the manual transcriptions are available only a training time. It does not try to sanitize the ASR transcriptions when the classifier is deployed.

The classifiers usually take the user utterance text and determine the destination of the call based on the inputted user utterance text. The classifier themselves are trained on just the user utterance text string, either human transcribed or ASR transcribed or both. As most ASR engines specify confidence scores for their hypothesis at word or phrase level, this information could be taken into account for improving classification accuracy. Matula et al as disclosed in “Improved LSI-Based Natural Language Call Routing Using Speech Recognition Confidence Scores”, in Proceedings of Empirical Methods in Natural Language Processing, 2004, tried improving the Natural Language call classification using speech recognition confidence scores generated with the N-best list. ASR confidence score for each unigram and bigram is obtained and the query vector is weighed using these confidence scores. The basic assumption behind this method was that words with high confidence scores and term vector values should influence the final selection more than words with low confidence scores and term vector values. The net effect is that when using confidence measures, the classifier may be led less astray by one or two misrecognized words, which may have a lower confidence score, and will be guided more by well recognized words which are steering the final result in a different direction. This technique uses the confidence scores of ASR for improving the accuracy however this is a method for selecting those transcriptions which is less noisy rather than trying to improve upon the noisy transcriptions.

### SUMMARY OF THE INVENTION

An aspect of the invention is to provide a method and a system for managing at least one speech-user-utterance in a speech classification system. The speech-user-utterance can be a spoken instruction used by a user so as to be directed to an appropriate department. The speech-user-utterance is classified to one of a plurality of pre-defined class types corresponding to various departments.

In order to fulfill above aspect, the method comprises training the speech classification system. The training step comprises manually converting at least one predefined-speech-user-utterance to a human-transcribed-text. Thereafter, the predefined-speech-user-utterance is transcribed automatically to obtain a set of automatic-transcribed-text. An automatic speech recognizer (ASR) can be used to automatically transcribe the predefined-speech-user-utterance. A relationship is then modeled between the human-transcribed-text and the set of automatic-transcribed-text. A probabilistic model can be used to model the relationship.

The method further comprises classifying the speech-user-utterance received at real-time from the user to one of the pre-defined class types. The classifying step comprises automatically transcribing the speech-user-utterance using an automatic speech recognizer (ASR) to obtain a set of automatic-transcribed-text, referred to as N-best automatic-transcribed-texts, corresponding to the speech-user-utterance. Further the classifying step comprises estimating the actual transcription of speech-user-utterance to get estimated-transcribed-text. An estimated-transcribed-text is an estimation corresponding to the set of automatic-transcribed-text based on the relationship modeled in the training step. Finally, the speech-user-utterance is classified to one of the plurality of pre-defined class types based on the corresponding estimated-transcribed-text.

The present invention also proposes a system for managing speech-user-utterances in a speech classification system. The system comprises a training module and a classifying module. The training module comprises an automatic-transcribing unit. The automatic-transcribing unit transcribes at least one predefined-speech-user-utterance to obtain a set of automatic-transcribed-text. The training module further comprises a modeling unit. The modeling unit models a relationship between a human-transcribed-text and each automatic-transcribed-text in the set of automatic-transcribed-text. The relationship can be modeled for a plurality of human-transcribed-texts determined at the training step. The system also comprises a classification module. The classification module comprises an automatic-transcribing unit for transcribing the speech-user-utterance to obtain a set of automatic-transcribed-text. Further, the classification module comprises an estimating unit for estimating an estimated-transcribed-text corresponding to the set of automatic-transcribed-text based on the relationship modeled by the modeling unit. Moreover, the classification module classifies the speech-user-utterance to one of the plurality of pre-defined class types based on the corresponding estimated-transcribed-text.

### BRIEF DESCRIPTION OF THE DRAWINGS

The foregoing objects and advantages of the present invention for a method and a system of speech classification may be more readily understood by one skilled in the art with reference being had to the following detailed description of several preferred embodiments thereof, taken in conjunction with the accompanying drawings wherein like elements are designated by identical reference numerals throughout the several views, and in which:

FIG. 1 illustrates flow diagram of a method for managing at least one speech-user-utterance in a speech classification system in accordance with an embodiment of the present invention.

FIG. 2 illustrates a method of classifying at least one speech-user-utterance to one of a plurality of pre-defined class types in accordance with an embodiment of the present invention.

FIG. 3 illustrates a block diagram of a system for managing at least one speech-user-utterance in a speech classification system in accordance with an embodiment of the present invention.

FIG. 4 illustrates a block diagram of an estimating unit in accordance with an embodiment of the present invention.

FIG. 5 illustrates a block diagram of an exemplary scenario where the present invention is deployed in real-time in accordance with an embodiment of the present invention.

### DETAILED DESCRIPTION

Before describing in detail embodiments that are in accordance with the present invention, it should be observed that the embodiments reside primarily in combinations of method steps and apparatus components related to a method and apparatus for speech classification. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that embodiments of the invention described herein may be comprised of one or more conventional processors and unique stored program instructions that control the one or more processors to implement, in conjunction with certain non-processor circuits, some, most, or all of the functions of the method and apparatus for facilitating speech classification. The non-processor circuits may include, but are not limited to, a radio receiver, a radio transmitter, signal drivers, clock circuits, power source circuits, and user input devices. As such, these functions may be interpreted as steps of a method for facilitating speech classification. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, the present invention deals with improving the accuracy of a speech classification system. For example, a user who wishes to know certain flight-information can call a helpline that employs the speech classification system. The user can use a speech-user-utterance and can follow certain instructions so as to be directed to an airline information department. The speech-user-utterance can, essentially, be the user's spoken message or query such as ‘what are the flight timings?’. The present invention provides a method and a system for interpreting the speech-user-utterance accurately so that the user is directed to an appropriate department and is caused minimum inconvenience due to misinterpretation of the speech-user-utterance.

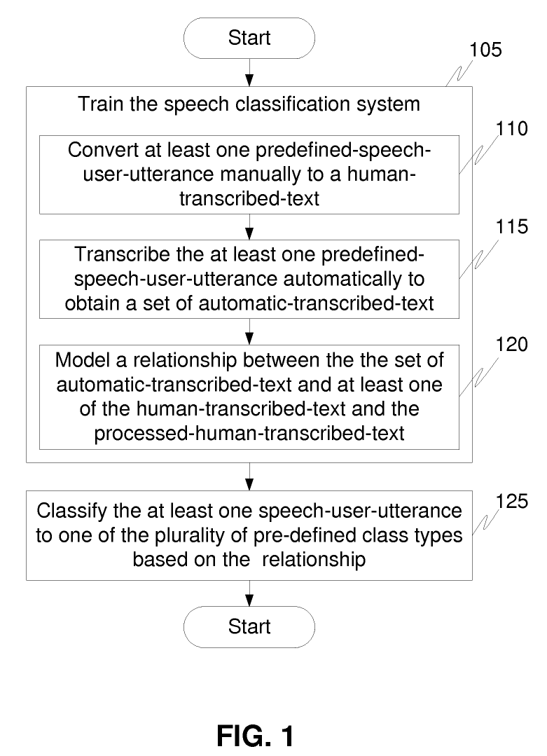

Referring now to FIG. 1, flow diagram of a method for managing at least one speech-user-utterance in a speech classification system is shown in accordance with an embodiment of the present invention. The speech-user-utterance of a user has to be classified to an appropriate pre-defined class type of a plurality of pre-defined class types so that the user is transferred to an appropriate department. However, the speech-user-utterance, if misinterpreted by the speech classification system, can be classified into a wrong pre-defined class type. It will be appreciated by those skilled in the art that a best performance of a speech classification system is obtained when the speech classification system is trained and tested on a human-transcribed-text. The human-transcribed-text is obtained when the user's speech-user-utterance is converted to text by a human. Human transcription is more accurate than transcription by an automatic speech recognizer (ASR). An ASR can be susceptible to many errors, for example due to noisy surroundings, the accent of the speaker or noisy transmission medium. This may lead to deletion, substitution or addition of certain words in the transcription of speech-user-utterance by the ASR.

However, obtaining a human-transcribed-text of a speech-user-utterance is not possible each time a user places a request. Therefore, in accordance with an embodiment of the present invention, a plurality of human-transcribed-texts, which are most likely to be encountered, can be stored prior to deploying the speech classifying system in real-time. The plurality of human-transcribed-texts can be used to train a statistical model. When a user calls, the user's speech-user-utterance can be transcribed to obtain at least one automatic-transcribed-text using an ASR. Usually, a predefined number, N, of best automatic-transcribed-texts, referred to as N-best automatic-transcribed-texts, are obtained using the ASR. The statistical model is then used in real-time to estimate an estimated-transcribed-text, which can be an actual transcription of the speech-user-utterance, from the automatic-transcribed text using the statistical model. Those skilled in the art will realize that the estimated-transcribed-text may not exactly match the stored human-transcribed texts. The user's speech-user-utterance can be classified into an appropriate pre-defined class type based on the estimated-transcribed-text, thus improving the accuracy of the speech classification system.

Referring back to FIG. 1, the speech classification system is trained at step 105. Those skilled in the art will realize that the speech classification system can be trained offline, for instance the speech classification system can be trained before the speech classification system is deployed in real-time. The training step, step 105, comprises converting at least one predefined-speech-user-utterance to a human-transcribed-text at step 110. In an embodiment of the present invention, a plurality of predefined-speech-user-utterances that are most likely to be encountered in a real-time scenario can be chosen for the training step. The human-transcribed-text is obtained by manually converting the predefined-speech-user-utterance to a text. Although a plurality of predefined-speech-user-utterances can be used to train the speech classification system, the present embodiment deals with only one predefined-speech-user-utterance in the interest of clarity. Those skilled in the art will realize that more the number of predefined-speech-user-utterances used for training, the higher will be the accuracy obtained by the speech classification system.

In an embodiment of the present invention, a plurality of human-transcribed-texts corresponding to a plurality of predefined-speech-user-utterances is labeled. The labeling can be done manually. These labels can each correspond to a different pre-defined class type to which the predefined-speech-user-utterance can be classified. These human-transcribed-texts along with their corresponding labels can be used to train the speech classification system.

In an embodiment of the present invention, a human-transcribed-text is pre-processed to obtain a processed-human-transcribed-text. Those skilled in the art will appreciate that the human-transcribed-text can be pre-processed based on a part-of-speech (POS) tagging, a morphing, a stemming, a tokenization or a parsing.

At step 115, the predefined-speech-user-utterance is transcribed automatically to obtain a set of automatic-transcribed-text corresponding to the predefined-speech-user-utterance. An ASR can be used to transcribe the predefined-speech-user-utterance automatically. Those skilled in the art will realize that, based on the set of automatic-transcribed-texts, the predefined-speech-user-utterance can be classified into any of the plurality of pre-defined class types. If an automatic-transcribed-text is erroneous, for instance due to misinterpretation of the predefined-speech-user-utterance, or due to deletion, substitution or addition of words, the predefined-speech-user-utterance can be directed to a wrong pre-defined class type.

In order to avoid misinterpretation of the predefined-speech-user-utterance, a relationship between the human-transcribed-text of the predefined-speech-user-utterance and the set of automatic-transcribed-text of the predefined-speech-user-utterance is modeled at step 120. A probabilistic model can be used to model a relationship. For example, at training time, a plurality of predefined-speech-user-utterances can be converted to obtain the corresponding human-transcribed-texts, at step 110, and the corresponding automatic-transcribed-texts, at step 115. The plurality of human-transcribed-texts, S_{T}, and corresponding plurality of automatic-transcribed-texts, S_{N}, are available at the training step 105. A statistical model, that probabilistically determined the relationship of a human-transcribed-text with an automatic-transcribed-text, is trained. The statistical model models a probability, P_{K} (S_{T}/S_{N}), that a human-transcribed-text, S_{T}, is a possible correct transcription of the predefined-speech-user-utterance, given an automatic-transcribed-text, S_{N}. K can be a parameter set of the statistical model. This can be done for each human-transcribed-text from the plurality of human-transcribed-texts and each automatic-transcribed-text from the plurality of automatic-transcribed-texts. Thus, the statistical model is learned from the human-transcribed-texts and the corresponding automatic-transcribed-texts available at the training time.

In an embodiment of the present invention, the plurality of human-transcribed-texts can be pre-processed to obtain a plurality of processed-human-transcribed-texts. A human-transcribed-text can be pre-processed based on a part-of-speech (POS) tagging, a morphing, a stemming, a tokenization or a parsing. The statistical model can, then, be trained on the processed-human-transcribed-texts and on the plurality of automatic-transcribed-texts using any of the conventional modeling techniques such as direct modeling techniques and indirect modeling techniques.

The training steps comprising the steps of transcribing the predefined-speech-user-utterance manually to obtain a human-transcribed-text, step 110, transcribing the predefined-speech-user-utterance automatically to obtain a set of automatic-transcribed-text, step 115, and modeling a relationship between the human-transcribed-text and the set of automatic-transcribed-text, step 120, can be performed offline, for instance before an actual user calls. The training steps can be performed for a plurality of predefined-speech-user-utterances. Those skilled in the art will realize that more the number of predefined-speech-user-utterances, higher will be the accuracy of the speech classification system.

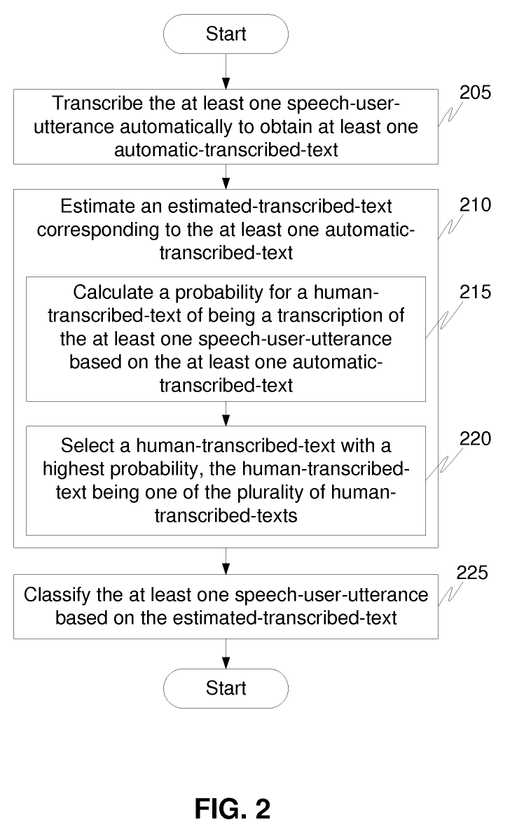

Upon training the speech classification system at step 105, the speech classification system can be deployed in real-time. For example, when a user places a request using a speech-user-utterance, the speech-user-utterance can be classified to an appropriate department. The user's speech-user-utterance can be classified at step 125 to one of the plurality of pre-defined class types based on the relationship modeled at step 120 during the training step 105. The specifics of the classifying step, step 125, are described in detail in conjunction with FIG. 2.

Those skilled in the art will realize that the speech classification system can be deployed in a variety of applications, for instance for routing calls in helpdesks, problem classification in customer care, airline enquiry systems, statistics collection in speech based enquiry or speech based reservation systems or for classifying speech in a natural language speech application.

Turning now to FIG. 2, a method of classifying at least one speech-user-utterance to one of a plurality of pre-defined class types is shown in accordance with an embodiment of the present invention. A speech classification system is deployed in real-time, therefore, a user can request the speech classification system for directing him to an appropriate pre-defined class type using the speech-user-utterance. The speech-user-utterance can be a spoken instruction given by the user so as to be directed to a certain department. When the speech classification system receives the speech-user-utterance, the speech-user-utterance is transcribed to obtain a set of automatic-transcribed-texts at step 205. The transcribing can be done automatically using an ASR. Those skilled in the art will realize that the automatic-transcribed-texts may not be an accurate transcription of the speech-user-utterance. Some of the words in the speech-user-utterance can be deleted, substituted or added while automatically transcribing the speech-user-utterance.

To avoid misinterpretation of the speech-user-utterance, an estimated-transcribed-text is estimated corresponding to the set of automatic-transcribed-texts at step 210. The estimated-transcribed-text can be estimated based on at least one statistical model. The statistical model is developed during training in the modeling step, step 120, of FIG. 1. In an embodiment of the present invention, the statistical model is based on a direct modeling technique. An example of the direct modeling technique is the maximum entropy modeling technique. In another embodiment of the present invention, the statistical model is based on an indirect modeling technique. An example of the indirect modeling technique is the statistical machine translation (SMT) system based on source channel technique and an n-gram replacement technique.

In an embodiment of the present invention, the statistical model probabilistically determines a relationship between a plurality of human-transcribed-texts, S_{T}, and a plurality of corresponding automatic-transcribed-texts, S_{N}, available at the training time, as described in FIG. 1. A probability for a human-transcribed-text of being a transcription of the speech-user-utterance based on at least one automatic-transcribed-text is calculated at step 215. The probability can be calculated for each of the plurality of human-transcribed-texts and each of the plurality of automatic-transcribed-texts corresponding to the speech-user-utterance. Further, the probability can be calculated based on a statistical model.

For instance, the estimated-transcribed-text, S′_{T}, can be estimated for the automatic-transcribed-text, S_{N}, corresponding to the speech-user-utterance. The estimated-transcribed-text, S′_{T}, is a human-transcribed-text from one of the plurality of human-transcribed-texts, S_{T}. A human-transcribed-text with a highest probability is selected as the estimated-transcribed-text, S′_{T}, at step 220. S′_{T} can be given by:

$${S}_{T}^{′} = {arg max}_{{S}_{T}} {P}_{K} ( {S}_{T} / {S}_{N} )$$

In another embodiment of the present invention, a Machine Translation (MT) technique is used to estimate the estimated-transcribed-text. Those skilled in the art will appreciate that the MT techniques are used to translate a text from one language (source language) to another (target language). A Statistical MT (SMT) system assumes that every sentence, t, in the target language is a possible translation of a sentence, s, in the source language. MT models P(t|s), which gives a probability of a target sentence t being a possible translation for a source sentence s. For finding a possible translation for a given source sentence s, a target sentence t′ is found such that Pr(t|s) is highest. The target sentence t′ can be obtained using the equation:

t′=argmaxₜPr(t|s)

Those skilled in the art will realize that in direct modeling techniques, such as maximum entropy modeling, the above equation can be used directly for computing the target sentence, t′, however, for indirect modeling techniques, the above equation may be broken into two components using bayes theorem.

By the virtue of bayes theorem:

Pr(t|s)=Pr(s|t)*Pr(t)/Pr(s)

Therefore, it can be deduced that:

t′=argmaxₜPr(t)*Pr(s|t)

The SMT system further creates a Language Model (LM), Pr(t), which models the correctness of the target sentence. A Translation Model (TM), Pr(s|t), can be used to find out the probability of a source sentence s given a target sentence t. Further, the target sentence t′ which maximizes the product of LM and TM probability can be found. The target sentences t are the plurality of human-transcribed-texts and the source sentences s are the plurality of automatic-transcribed-texts in context of the present invention. This target sentence, t′, in context of the present invention, therefore is the estimated-transcribed-text. Thus the target sentence, t′, can be selected from a plurality of target sentences, t, at step 220.

The process of learning the LM and the TM is done during the training step, step 105 of FIG. 1. However, the target sentence t′ (the estimated-transcribed-text) for a given source sentence s (an automatic-transcribed-text), which maximizes the product of LM probability and TM probability, is selected at real-time when a speech-user-utterance is received. The learning of the LM and the TM may require a monolingual corpus and a parallel corpus respectively. Those skilled in the art will realize that the parallel corpus is a sentence-by-sentence translation pair of the source sentences and the target sentences. In accordance with the present invention, during the training, a set of automatic-transcribed-text, S_{N}, along with a corresponding human-transcribed-text, S_{T}, form parallel corpora. For each automatic-transcribed-text of every predefined-speech-user-utterance in the training step, step 105, the corresponding human-transcribed-text forms the parallel corpus. The automatic-transcribed-text is used as the source language and the human-transcribed-text-is used as the target language. This parallel corpus can be used to train the statistical MT (SMT) system.

In an embodiment of the present invention, the statistical model can be trained on a plurality of processed-human-transcribed-texts and on a plurality of automatic-transcribed-texts using any of the conventional modeling techniques. As mentioned earlier, the human-transcribed-texts can be pre-processed to obtain the plurality of processed-human-transcribed-texts. A human-transcribed-text can be pre-processed based on a part-of-speech (POS) tagging, a morphing, a stemming, a tokenization or a parsing. Those skilled in the art will realize that, by the virtue of this embodiment, the estimated-transcribed-text may not exactly match the human-transcribed texts. However, the estimated-transcribed-text can be derived using the processed-human transcribed-texts.

When the speech-user-utterance is received at real-time at the speech classification system, only the automatic-transcribed-text is obtained at step 205. In an embodiment of the present invention, in the estimation step, step 210, a predefined number, N, of automatic-transcribed-texts, referred to as N-best automatic-transcribed-texts, that are most closely related to the speech-user-utterance are obtained. Each of the N-best automatic-transcribed-texts can be inputted into a machine translator to estimate a human-transcribed-text with the highest probability. A plurality of class scores of a predetermined number, M, of possible pre-defined class types, in which the speech-user-utterance can be classified to, is obtained. Hence, for the N-best automatic-transcribed-texts and M pre-defined class types, N×M scores can be available. Usually, the speech-user-utterance is classified to a top pre-defined class type of the M pre-defined classes. The top pre-defined class type can be a pre-defined class type corresponding to the human-transcribed-text with the highest probability. Alternatively, a confidence score can be associated with each of the N-best automatic-transcribed-texts. The confidence scores and the class scores of the pre-defined class types can be used to classify the speech-user-utterance to an appropriate pre-defined class type.

In an embodiment of the present invention, apart from using the N-best automatic-transcribed-texts and the class scores of the pre-defined class types, the pre-defined class types can be weighted using the LM and the TM probabilities given by the SMT system. The pre-defined class types with high LM and TM probabilities can be given higher weights than the pre-defined class types with low LM and TM probabilities. Those skilled in the art will appreciate that a higher probability can imply a higher confidence that the estimation is correct.

Those skilled in the art will appreciate that a product of TM probability and LM probability can give an overall measure of confidence in the human-transcribed-texts. The TM probability and the LM probability can be normalized by dividing the TM and LM scores with the lowest confidence score. This makes the lowest confidence score equal to one. The higher confidence scores get weights higher than one. The human-transcribed-text with a highest confidence score is chosen as the estimated-transcribed-text at step 210. The speech-user-utterance can then be classified based on the estimated-transcribed-text, at step 225, and the user can be directed to an appropriate pre-defined class type.

Another embodiment of the present invention uses an N-gram replacement model for modeling a relationship between the plurality of human-transcribed-texts and the plurality automatic-transcribed-texts during the training steps. The model uses Bayes theorem to estimate an estimated-transcribed-text from the human-transcribed-texts n-grams given the N-best automatic-transcribed-texts n-grams. The Bayes theorem is known in the art. The probability of the human-transcribed-texts n-gram given the N-best automatic-transcribed-texts n-grams can be given by the Bayes theorem as:

$$P ( {t}_{i} \vert {w}_{j} ) = \frac{P ( {w}_{j} \vert {t}_{i} ) P ( {t}_{i} )}{P ( {w}_{j} )}$$

Where tᵢ is the human-transcribed-text n-gram and wⱼ is a corresponding N-best automatic-transcribed-text n-gram. The numerator is a measure of co-occurrence of tᵢ and wⱼ. The values of these probabilities may need to be obtained during the training steps, step 105, of FIG. 1.

The automatic-transcribed-texts can comprise several errors such as deletion, substitution or addition. Addition and deletions can destroy a one-to-one correspondence between the N-best automatic-transcribed-texts n-grams and the human-transcribed-texts n-grams. Thus, as an approximation, a moving window of, say, size three can be considered. For each of the N-best automatic-transcribed-texts, three words in the human-transcribed-texts from a current position of the N-best automatic-transcribed-text can be considered. For instance, to find the co-occurrence of i^{th} word in an N-best automatic-transcribed-text, words in the i^{th}, (i+1)^{th} and (i+2)^{th} position in a human-transcribed-text can be considered. If there is a match with any of these words, only that co-occurrence may be considered. If a match cannot be found, all may correspond to the same N-best automatic-transcribed-texts n-gram.

Hence, in the present embodiment, during the training step, step 105, a matrix containing the N-best automatic-transcribed-texts n-grams as rows and the human-transcribed-texts n-grams as columns can be formed. Each element (i, j) in the matrix can give the number of co-occurrences of the i^{th} N-best automatic-transcribed-text with j^{th} human-transcribed-text. Each element can be divided by a sum of the elements in the corresponding row to give a plurality of posterior probabilities. The matrix may turn out to be big and the computational complexity may, in turn, increase. Those skilled in the art will realize that the computational complexity can be reduced to a considerable extent if only unigrams are considered. However, unigrams may lead to reduced accuracy.

When the speech-user-utterance is received by the speech classification system in real-time, the N-best automatic-transcribed-texts n-grams can be replaced with corresponding human-transcribed-texts n-grams such that the human-transcribed-texts with the highest posterior probability are chosen.

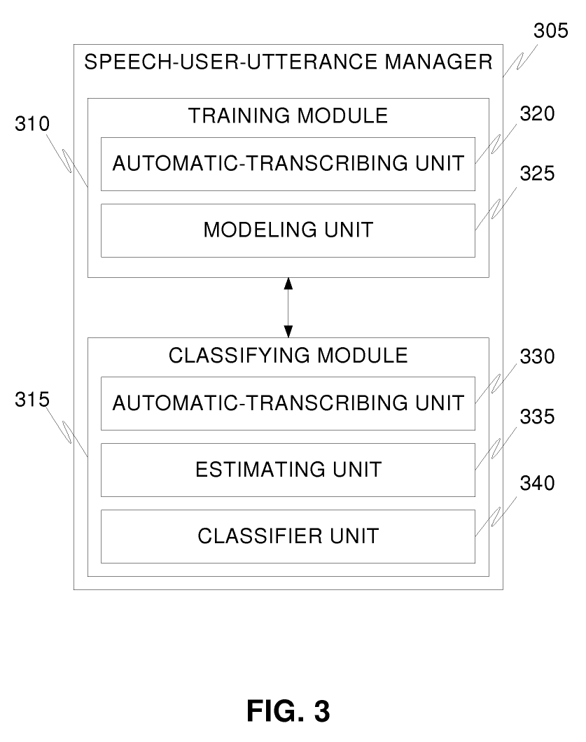

Turning now to FIG. 3, a block diagram of a system for managing at least one speech-user-utterance in a speech classification system is shown in accordance with an embodiment of the present invention. A system 305 enables a speech-user-utterance to be classified to one of a plurality of pre-defined class types. System 305 can be a software computer program residing on the speech classification system. System 305 comprises a training module 310 and a classifying module 315. Training module 310 is used to train the speech classification system offline, for instance before deploying the speech classification system in real-time. Whereas, classifying module 315 is used in real-time to route a user to an appropriate pre-defined class type in.

During training, at least one predefined-speech-user-utterance is converted to a human-transcribed-text manually. The predefined-speech-user-utterance is also transcribed to obtain a set of automatic-transcribed-texts using an automatic-transcribing unit 320 in training module 310. Automatic-transcribing unit 320 can be an ASR. In an embodiment of the present invention, a predefined number, N, of best possible automatic-transcribed-texts, N-best, corresponding to the speech-user-utterance are found. An ASR can be used to transcribe the predefined-speech-user-utterance automatically. In an embodiment of the present invention, a plurality of predefined-speech-user-utterances that are most likely to be encountered in a real-time scenario can be chosen for training. The plurality of human-transcribed-texts and the plurality automatic-transcribed-texts corresponding to the plurality of predefined-speech-user-utterances can be stored in a memory in the speech classification system.

Those skilled in the art will realize that, based on the set of automatic-transcribed-texts, the predefined-speech-user-utterance can be classified into any of a plurality of pre-defined class types. If an automatic-transcribed-text is erroneous, for instance due to misinterpretation of the predefined-speech-user-utterance, or due to deletion, substitution or addition of words, the predefined-speech-user-utterance can be directed to a wrong pre-defined class type.

In order to avoid misinterpretation of the predefined-speech-user-utterance, a relationship between the human-transcribed-text of the predefined-speech-user-utterance and the set of automatic-transcribed-texts of the predefined-speech-user-utterance can be modeled using a modeling unit 325 in training module 310. A probabilistic model can be employed by modeling unit 325 to model a relationship between a plurality of human-transcribed-texts and a plurality of automatic-transcribed-texts corresponding to a plurality of predefined-speech-user-utterances. Modeling unit 325 can indicate a probability of a human-transcribed-text given an automatic-transcribed-text. This can be done for each human-transcribed-text and each automatic-transcribed-text.

When a user places a request using a speech-user-utterance to the speech classification system, the speech-user-utterance is transcribed automatically to obtain a set of automatic-transcribed-texts corresponding to the speech-user-utterance using an automatic-transcribing unit 330 in classifying module 315. Automatic-transcribing unit 330 can be an ASR. Automatic-transcribing unit 330 can be the same automatic-transcribing unit as the automatic-transcribing unit 320. Those skilled in the art will realize that the automatic-transcribed-texts in the set of automatic-transcribed-texts may be erroneous, for instance, some of the words in the speech-user-utterance may be deleted or substituted or new words may be added during automatically transcribing the speech-user-utterance. These errors may lead to misinterpretation of the speech-user-utterance. To avoid the misinterpretation, an estimating unit 335 estimates an estimated-transcribed-text from the plurality of human-transcribed-text stored in the memory. The estimated-transcribed-text is the human-transcribed-text that has a highest probability of being the speech-user-utterance. The probability of a human-transcribed-text of being a transcription of the speech-user-utterance, given an automatic-transcribed-text corresponding to the speech-user-utterance, can be calculated at real-time using a Machine Translation technique or an N-gram replacement technique.

In an embodiment of the present invention, the human-transcribed-text is pre-processed to obtain a processed-human-transcribed-text. The human-transcribed-text can be pre-processed based on a part-of-speech (POS) tagging, a morphing, a stemming, a tokenization or a parsing. Modeling unit 325 can model a relationship between the processed-human-transcribed-text and the second set of automatic-transcribed-text. Estimating unit 335 can, then, estimates the estimated-transcribed-text based on the relationship. Those skilled in the art will realize that, by the virtue of this embodiment, the estimated-transcribed-text may not exactly match the human-transcribed texts. However, the estimated-transcribed-text can be derived using the processed-human transcribed-texts.

The speech-user-utterance can then be classified by a classifier unit 340 to one of the plurality of pre-defined class types based on the estimated-transcribed-text estimated at estimating unit 335.

In the embodiment where N-best automatic-transcribed-texts are determined corresponding to the speech-user-utterance, probability of each human-transcribed-text being each of the N-best automatic-transcribed-text can calculated. Each of the N-best automatic-transcribed-texts can be inputted into a machine translator to estimate a human-transcribed-text with the highest probability. A plurality of call scores of a predetermined number, M, of possible pre-defined class types, in which the speech-user-utterance can be classified to, is obtained. Hence, for the N-best automatic-transcribed-texts and M pre-defined class types, N×M scores can be available. Usually, the speech-user-utterance is classified by classifier unit 340 to a top pre-defined class type of the M pre-defined classes. The top pre-defined class type can be a pre-defined class type corresponding to the human-transcribed-text with the highest probability.

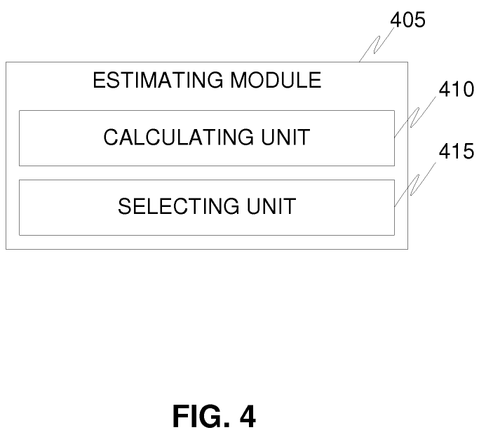

Turning now to FIG. 4, a block diagram of an estimating unit 405 is shown in accordance with an embodiment of the present invention. Estimating unit 335 of FIG. 3 is depicted as estimating unit 405 in FIG. 4. Estimating unit 405 estimates an estimated-transcribed-text corresponding to a speech-user-utterance received at a speech classification system in real-time. The estimated-transcribed-text is derived from one or more of a plurality of human-transcribed-texts stored while training the speech classification system. Estimating unit 405 comprises a calculating unit 410. Calculating unit 410 calculates a probability for an estimated-transcribed-text of being a transcription of the speech-user-utterance. Those skilled in the art will realize that, by the virtue of this embodiment, the estimated-transcribed-text may not exactly match the human-transcribed texts. However, the estimated-transcribed-text can be derived using the processed-human transcribed-texts.

In an embodiment of the present invention, a set of automatic-transcribed text corresponding to the speech-user-utterance is inputted to calculating unit 410. Calculating unit 410 can, then, calculate a probability of each human-transcribed-text being a transcription of the speech-user-utterance for each of the automatic-transcribed-text. The probability can be calculated based on a statistical model. The statistical model can be based on, for example SMT system or N-gram replacement model.

Estimating unit 405 further comprises a selecting unit 415. Selecting unit 415 selects a human-transcribed-text with a highest probability as an estimated-transcribed-text. This estimated-transcribed-text can be used to classify the speech-user-utterance to an appropriate pre-defined class type.

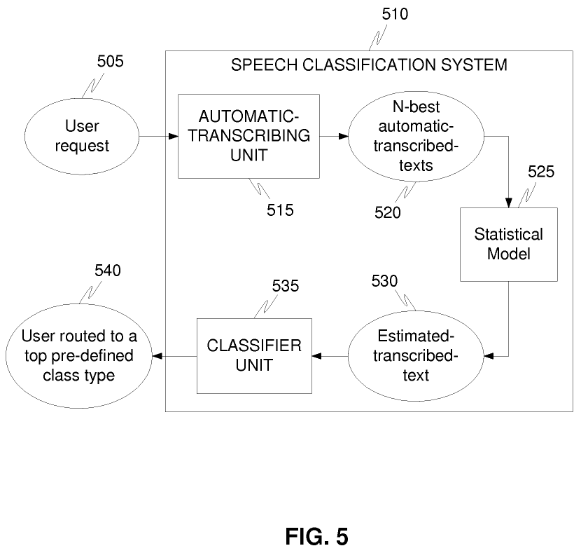

Turning now to FIG. 5, a block diagram of an exemplary scenario where the present invention is deployed in real-time is shown in accordance with an embodiment of the present invention. A user places a user request 505 to a speech classification system 510. User request 505 is a speech-user-utterance. An automatic transcribing unit 515 in speech classification system 510 transcribes user request 505 to obtain N-best automatic-transcribed-texts 520 corresponding to user request 505. Automatic transcribing unit 515 is automatic transcribing unit 320 described in FIG. 3.

A statistical model 525 processes N-best automatic-transcribed-texts 520. As mentioned earlier, statistical model 525 can be trained offline using human-transcribed-texts corresponding to a plurality of predefined-speech-user-utterances. Each of the human-transcribed-texts has an associated pre-defined class type. In an embodiment of the present invention, the human-transcribed-texts are pre-processed to obtain processed-human-transcribed-texts. The human-transcribed-texts can be pre-processed based on a part-of-speech (POS) tagging, a morphing, a stemming, a tokenization or a parsing. FIG. 1 describes a method of training statistical model 525 in detail.

Each of N-best automatic-transcribed-texts 520 can be used by statistical model 525 to give at least one human-transcribed-text or at least one processed-human-transcribed-text which has the highest probability of being a transcription of user request 505. In case statistical model 525 gives a processed-human-transcribed-text, the processed-human-transcribed-text is post-processed to remove any part-of-speech (POS) tagging, a morphing, a stemming, a tokenization or a parsing. An estimated-transcribed-text 530 is obtained from the at least one human-transcribed-text or the at least one processed-human-transcribed-text, which has been post-processed. The method of obtaining estimated-transcribed-text 530 is described in detail in FIG. 2.

A classifier unit 535, then, classifies estimated-transcribed-text 530 to a top pre-defined class type. Classifier unit 535 is classifier unit 340 described in FIG. 3. The top pre-defined class type is the class type that is assigned highest classification score by the classifier unit. The user is, then, routed to an appropriate department corresponding to the top pre-defined class type at 540.

The various embodiments of the present invention provide a method and system for improving the accuracy of a speech classification system, such as an Automatic Natural Language Call Classification system, using statistical models. The present invention makes use of the fact that the speech classification system gives best performance when the speech classifying system is trained and tested on a plurality of human-transcribed-texts. Automatic transcriptions using ASR may yield erroneous transcriptions and the speech classification system may divert a user to a wrong pre-defined class type. Therefore, the present invention uses a plurality of predefined-speech-user-utterances to train the speech classification system. The speech classification system can be trained dynamically, for example, the speech classification system can be trained each time a new speech-user-utterance is encountered, thus, updating the speech classification system and making it more accurate.

The present invention can be used in conjunction with conventional speech classification techniques such as improving a classifier using boosting or discriminative training or incorporating relevant feedback or confidence scores to attain further improvement.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as critical, required, or essential features or elements of any or all the claims.

What is claimed is:

1. A method for classifying at least one speech-user-utterance to one of a plurality of pre-defined class types, the method comprising the steps of:
a. transcribing the at least one speech-user-utterance to obtain at least one automatic-transcribed-text, wherein the transcribing is done automatically, wherein the at least one automatic-transcribed-text corresponds to the at least one speech-user-utterance;
b. estimating an estimated-transcribed-text corresponding to the at least one automatic-transcribed-text, the estimated-transcribed-text being estimated based on at least one statistical model; and
c. classifying the at least one speech-user-utterance based on the estimated-transcribed-text.

2. The method of claim 1, wherein the transcribing step comprises transcribing the at least one speech-user-utterance using an automatic speech recognizer.

3. The method of claim 1, wherein the at least one statistical model is based on one of a direct modeling technique and an indirect modeling technique.

4. The method of claim 3, wherein the direct modeling technique is a maximum entropy modeling technique.

5. The method of claim 3, wherein the indirect modeling technique is a statistical machine translation (SMT) system based on a source channel technique and an n-gram replacement technique.

6. The method of claim 1, wherein the step of estimating comprises:
a. calculating a probability for a human-transcribed-text of being a transcription of the at least one speech-user-utterance based on the at least one automatic-transcribed-text, the probability being calculated for each of a plurality of human-transcribed-texts, the probability being calculated based on a statistical model; and
b. selecting a human-transcribed-text with a highest probability, the human-transcribed-text being one of the plurality of human-transcribed-texts.

7. A method for managing at least one speech-user-utterance in a speech classification system, the at least one speech-user-utterance being classified to one of a plurality of pre-defined class types, the method comprising:
a. training the speech classification system, the training step comprising:
i. converting at least one predefined-speech-user-utterance to a human-transcribed-text, the converting being done manually;
ii. transcribing the at least one predefined-speech-user-utterance to obtain a first set of automatic-transcribed-text, wherein the at least one predefined-speech-user-utterance is transcribed automatically using an automated speech recognizer; and
iii. modeling a relationship between the human-transcribed-text and the first set of automatic-transcribed-text, wherein a probabilistic model is used to model the relationship.
b. classifying the at least one speech-user-utterance, the classifying step comprising:
i. transcribing the at least one speech-user-utterance to obtain a second set of automatic-transcribed-text corresponding to the at least one speech-user-utterance, the transcribing being done automatically;
ii. estimating an estimated-transcribed-text corresponding to the second set of automatic-transcribed-text based on the relationship modeled in the training step; and
iii. classifying the at least one speech-user-utterance to one of the plurality of pre-defined class types based on the corresponding estimated-transcribed-text.

8. The method of claim 7, wherein the speech classification system is trained offline.

9. The method of claim 7, wherein the at least one speech-user-utterance is classified in real-time.

10. The method of claim 7, wherein the human-transcribed-text is pre-processed to obtain a processed-human-transcribed-text, wherein the human-transcribed-text is pre-processed based on at least one of a part-of-speech (POS) tagging, a morphing, a stemming, a tokenization and a parsing.

11. The method of claim 7, wherein the estimated-transcribed-text is estimated based on a relationship, the relationship being modeled between the processed-human-transcribed-text and the first set of automatic-transcribed-text.

12. The method of claim 7, wherein the speech classification system routes a voice call to a pre-defined class type, the pre-defined class type corresponding to an appropriate department.

13. A system for managing at least one speech-user-utterance in a speech classification system, the at least one speech-user-utterance being classified to one of a plurality of pre-defined class types, the system comprising:
a. a training module, the training module comprises:
i. a first automatic-transcribing unit, the first automatic-transcribing unit transcribing at least one predefined-speech-user-utterance to obtain a first set of automatic-transcribed-text; and
ii. a modeling unit, the modeling unit modeling a relationship between a human-transcribed-text and each automatic-transcribed-text in the first set of automatic-transcribed-text, wherein a probabilistic model is used to model the relationship, wherein the at least one predefined-speech-user-utterance is transformed manually to obtain the human-transcribed-text.
b. a classifying module, the classifying module comprises:
i. a second automatic-transcribing unit, the second automatic-transcribing unit transcribing the at least one speech-user-utterance to obtain a second set of automatic-transcribed-text;
ii. an estimating unit, the estimating unit estimating an estimated-transcribed-text corresponding to the second set of automatic-transcribed-text based on the relationship modeled by the modeling unit; and
iii. a classifier unit, the classifier unit classifying the at least one speech-user-utterance to one of the plurality of pre-defined class types based on the corresponding estimated-transcribed-text.

14. The system of claim 13, wherein the estimating unit comprises:
a. a calculating unit, the calculating unit calculating a probability for a human-transcribed-text of being a transcription of the at least one speech-user-utterance based on the second set of automatic-transcribed-text, the probability being calculated for each of a plurality of human-transcribed-texts, the probability being calculated based on a statistical model; and
b. a selecting unit, the selecting unit selecting a human-transcribed-text with a highest probability.

15. The system of claim 13, wherein the human-transcribed-text is pre-processed to obtain a processed-human-transcribed-text, wherein the human-transcribed-text is pre-processed based on at least one of a part-of-speech (POS) tagging, a morphing, a stemming, a tokenization and a parsing.

16. The system of claim 15, wherein the estimating unit estimates the estimated-transcribed-text based on a relationship, the relationship being modeled between the processed-human-transcribed-text and the second set of automatic-transcribed-text.
